(19) United States
(12) Patent Application Publication
(10) Pub. No.: US 2024/0193271 A1
(43) Pub. Date: Jun. 13, 2024

(54) ANOMALY DETECTION FRAMEWORK TARGETING RANSOMWARE USING LOW-LEVEL HARDWARE INFORMATION

(71) Applicants: Chen Liu, Potsdam, NY (US); Chutitep Woralert, Potsdam, NY (US)

(72) Inventors: Chen Liu, Potsdam, NY (US); Chutitep Woralert, Potsdam, NY (US)

(73) Assignee: CLARKSON UNIVERSITY, Potsdam, NY (US)

(21) Appl. No.: 18/538,875

(22) Filed: Dec. 13, 2023

Related U.S. Application Data
(60) Provisional application No. 63/432,087, filed on Dec. 13, 2022.

(51) Int. Cl. G06F 21/56

(52) U.S. Cl. CPC G06F 21/56; G06F 2221/034

(57) ABSTRACT

A semi-supervised machine learning system and method to detect ransomware using low-level hardware information. Employing semi-supervised learning method on performance counter data for anomaly prediction, the system can detect ransomware in real-time with its online detection process.

### CROSS-REFERENCE TO RELATED APPLICATION

The present invention relates and claims priority to U.S. Provisional Patent Application No. 63/432,087, filed Dec. 13, 2022, the entire disclosure of which is hereby incorporated by reference.

### GOVERNMENT FUNDING

N/A

### FIELD OF THE INVENTION

The present disclosure is directed generally to a semi-supervised machine learning system and method to detect ransomware using low-level hardware information.

### BACKGROUND

Recent years have witnessed a surge in ransomware, one of the most notorious malware attacks. Many tools have been developed to combat against ransomware attacks, however, many a new variant of ransomware has continued to emerge, employing more advanced techniques distributing the payload while avoiding detection. This renders the traditional static ransomware detection mechanism ineffective.

Ransomware is a form of malware designed to prevent the user from accessing the data by encrypting the user's files. After the data is encrypted, the attacker then demands a ransom to be paid by the user. If the ransom is not paid by the deadline, the data can be lost. Because ransomware vandalizes the data on the victim's systems, the manpower and financial cost required to fix the damage can create a huge burden to the victim. In recent years, ransomware has become more rampant in the cyber world [1], while the scope and target of ransomware attacks are also on the rise. Associated with this, we have seen ransomware variants incorporate advanced features ranging from preventing the user from accessing the system entirely, data exfiltration to disclose the user's confidential data to the dark web, to deploying detection evasion techniques to avoid being detected by defense programs.

A wide variety of tools have been developed to help combat against ransomware. Because ransomware usually generates abnormal amounts of file system activities in terms of files being modified and moved around, Kharaz et al. [2] and Back et al. [3] proposed detection tools taking advantage of such behaviors exhibited during the attack. Almashhadani et al. [4] proposed a different type of ransomware detection method by observing the anomaly in the network traffic during the attack.

On the other hand, performance counters have been introduced to measure and analyze the behavioral patterns of the program. Originally, performance counters were used to optimize the performance of the program by identifying the bottleneck during the program execution. There are many previous literatures that proposed the use of performance counters for malware detection [5, 6, 7]. Many techniques have been developed to enhance the detection accuracy of the classifier. However, the protection of the detection module has often been overlooked, which could leave the detection module itself vulnerable to the attack. Also, the resource requirement for real-time deployment of the detection framework and the possibility of noise interference generated during the system monitoring are not well addressed by many of the previous works.

Accordingly, there is a need in the art for a real-time ransomware detection method and system.

### SUMMARY

The present disclosure is directed to an anomaly detection framework targeting ransomware using low-level hardware information.

A computing framework that employs semi-supervised machine learning method to detect ransomware using low-level hardware information. A classification engine (classifier) design, the temporal aspect of hardware-level information formed as time series to detect deviation in system behavior is taken into consideration, thereby increasing the detection accuracy whilst reducing the number of false positives. What's more, by having a separate machine for the classifier while the user machine is under monitoring, it allows the classifier machine to enforce strict protection and offload the heavy-weight classification work, without impeding the functionality of the user machine. This hierarchical design enables good scalability for the proposed framework.

According to an aspect is a system for detecting malware on a user computer, comprising a data collection module comprising profiling software stored and adapted to e executed on the user computer, the profiling software collecting data of hardware events occurring on the user machine based at predetermined intervals and using the collected data to compile a performance counter data structure; a data classification module comprising a recurrent neural network stored and adapted to be executed on a classifier machine that is separate from the user machine, the recurrent neural network processing the performance counter data structure and outputting a classification output that categorizes the data as benign or malicious; and means for notifying an administrator of the classification output.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a block diagram of a framework architecture, in accordance with an embodiment.

FIG. 2 is a performance counter event counter graph, in accordance with an embodiment.

FIG. 3 is a block diagram of an LSTM network architecture, in accordance with an embodiment.

FIG. 4 is a series of graphs showing LSTM output anomaly level for a system under attack, in accordance with an embodiment.

FIG. 5 is a series of graphs showing LSTM output anomaly level for system benign

behavior, in accordance with an embodiment.

FIG. 6 is a graph showing a WMV output for system benign behavior, in accordance with an embodiment.

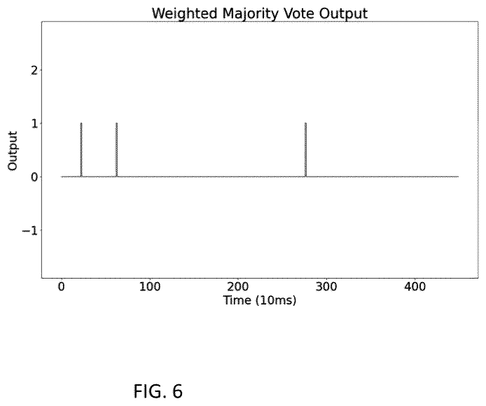

FIG. 7 is a graph showing EMA output for system benign behavior, in accordance with an embodiment.

FIG. 8 is a high-level flow diagram showing the system architecture, in accordance with an embodiment.

### DETAILED DESCRIPTION OF EMBODIMENTS

The present disclosure describes a semi-supervised machine learning system and method to detect ransomware using low-level hardware information. As used herein, the acronym HARD-Lite will be used to refer to the Lightweight (Lite) Hardware Anomaly Realtime Detection (HARD) framework, designated generally by reference numeral 10. Employing semi-supervised learning method on performance counter data for anomaly prediction, HARD-Lite can detect ransomware in real-time with its online detection process.

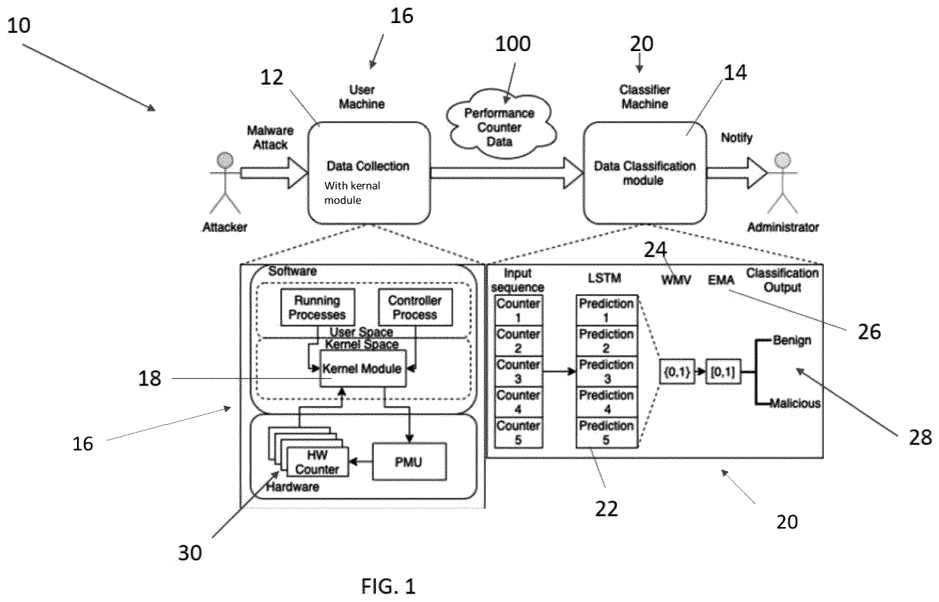

Referring to FIG. 1, in one embodiment, is shown the HARD-Lite framework which comprises two components: the data collection module 12 and the classifier module 14. The data collection module 12 is deployed on a user computing machine 16 to collect the hardware event data from selected performance counters at run-time using a kernel module 18 (which can also be achieved by using other program profiling tools), while the classifier module 14 is deployed on the server machine 20 to monitor the user machine behavior and perform detection. It employs an LSTM model 22 as the classifier, which was trained using only benign behavior data of the user machine 16, following the semi-supervised learning method. The output of the LSTM model 22 will go through a Weighted Majority Voting (WMV) Ensemble 24 to compact the results, and an Exponential Moving Average (EMA) filter 26 for smoothing, before reporting/outputting the system behavior as benign or malicious as classification output 28. By offloading the computation-intensive classification workload from the user machine 16 to the server machine 20, the classifier module 14 will not be detected by sophisticated ransomware with detection avoidance capability.

For the profiling software, the kernel module is preferably a customized module to set up/probe the data from the hardware counters as illustrated in FIG. 1. On the user machine, the data collection module is set up to monitor the system behavior. During the initialization process, the kernel module will set up the Performance Monitoring Unit (PMU) for the hardware event counting. The kernel module parameters such as the specific hardware events to monitor, monitoring privilege, and timer frequency to probe the data, etc., can be configured. After the initialization, the kernel module will periodically probe the hardware counter data and arrange the data into the time series format then pass the data back to the controller process, which is described hereinafter.

As taught above, the present invention uses a kernel module-based approach to collect hardware event counter data, instead of a “perf”, which is a Linux built-in profiling tool. While replacing the kernel module-based approach with perf-based approach, the overall design still works, that is, it can still connect with the data classification module and we can still perform anomaly detection, as all that is needed is a way to collect hardware event data on the user machine and send them over to the classifier machine for classification. The kernel module design, however, has been shown to have lower overhead than perf when collecting hardware events on the user machine, while providing the same level of accuracy as perf when collecting hardware events.

### Performance Counter Data Collection

In this framework, a system profiling tool is needed to monitor system-wide user-level hardware events periodically. The present invention uses K-LEB, an in-house developed system profiling tool, which can also be achieved by using other program profiling tools. To collect performance counter data in a time-series format, the profiling tool is set to extract and log the system's performance counter 30 at a predefined interval, such as 10 ms. The performance counter data log 100 collected on the user machine 16 is then passed to the classifier 14 running on the server machine 20 at a predefined interval, such as 500 ms, where the latter will perform online classification on the data continuously. To provide an extra layer of protection, the data log 100 is not stored on the user machine 16, as a precaution in case the user machine 16 is compromised. Additionally, to prevent the data from being captured and exposed during the transmission, the data log 100 is sliced using sliding windows and encrypted, then passed individually via secure SSH tunnels to the classifier machine 14. In case of a data leak, the slices of the data log would not provide any substantial information to the attacker. The full data log is reassembled and stored on the classifier machine 14, which will be contained in a more secure environment with more strict security enforcement than the user machine 16.

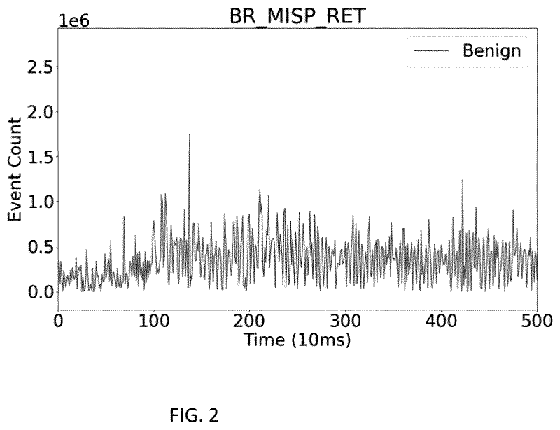

The hardware counter data is collected and formatted as time series data, as shown in FIG. 2, where each data point represents the number of the system performance counter event that occurred during one time period, in this case every 10 ms. Because the time series can be very long (as we collect data continuously), the data is split up and periodically passed to the classifier machine for further processing and classifying. As shown in FIG. 1, multiple of these time series data are taken, with each series corresponding to one specific hardware event, and then the data is transmitted to the classification machine, where the machine learning module for classification is run to determine if it is benign or malicious behavior, which we will be described hereinafter.

### Classification Model for Time Series Data

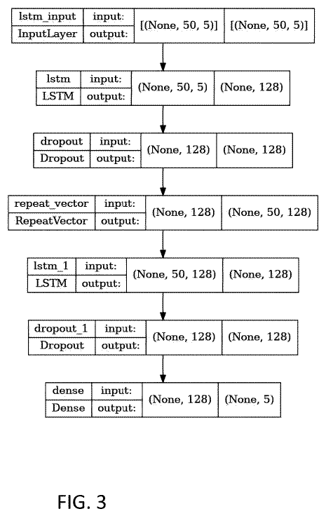

In this work, the LSTM architecture, shown in FIG. 3, is used as part of the classification pipeline. The LSTM architecture is a type of Recurrent Neural Network (RNN) which mitigates the problem of vanishing gradients in RNNs. The LSTM model is used for forecasting, i.e., given past events the LSTM network tries to predict the next element in the time series. The forecasting network was trained with the goal of successfully predicting the next time step from the previous N time steps. The model can be developed and implemented using common machine learning framework, such as TensorFlow. Since the model is trained on benign data only, it is expected that the prediction error will be large when anomalous behavior begins to occur. Therefore, for each feature, if the prediction error is too large, that particular time step is flagged as anomalous, with a predefined decision threshold. For classification decision induced by each feature, a weight is assigned based on the utility of each feature for malware detection. Lastly, a final threshold is introduced which controls what fraction of the vote is required to label a particular sample as anomalous.

### Pattern Behavior of Ransomware and Feature Selection

The behavior pattern of the system can be monitored by monitoring the hardware events. Each hardware event represents a specific task or behavior that occurred during the program execution. However, due to hardware limitations, only limited number of hardware events can be monitored concurrently. To deploy the framework online to perform real-time detection of ransomware, it is important to select the most relevant hardware events as features for model building. To decide which hardware events are better features to use to build the classifier, the Receiver Operating Characteristic (ROC) curve is calculated to determine the performance characteristics exhibited during the ransomware attack of different hardware events. Then the Area Under the Curve (AUC) of the ROC curve is calculated to measure the utility of different hardware events towards ransomware detection. Based on these results, the most effective hardware events are selected to use to monitor.

### Machine Learning Model Architecture

On the classifier machine, the data is reassembled and preprocessed by making sliding windows before passing them to the data classification module. The machine-learning (ML) based classifier model is trained using only the benign behavior of the system in order to build a baseline behavior of the system. This is called one-class classifier, or semi-supervised learning approach, as only benign behavior is used during the training of the ML model.

The LSTM network architecture is shown in FIG. 3. For this work, the Long Short-Term Memory (LSTM) autoencoder model is used to predict the next input based on the current time sliding window to calculate the anomaly level of the current data. The input features are the event counts for each hardware event. LSTM is good for time series prediction because of its ability to remember previous inputs for a long period of time, which is exactly what we have.

It is noteworthy that the present framework work can support two-class classifier, as long as during the ML model training stage, so long as collecting the data of ransomware behavior as malicious data to train the model (noting benign behavior data is already available). Then the same design as shown in FIG. 1 can be followed by just replacing the one-class LSTM model with two-class LSTM model.

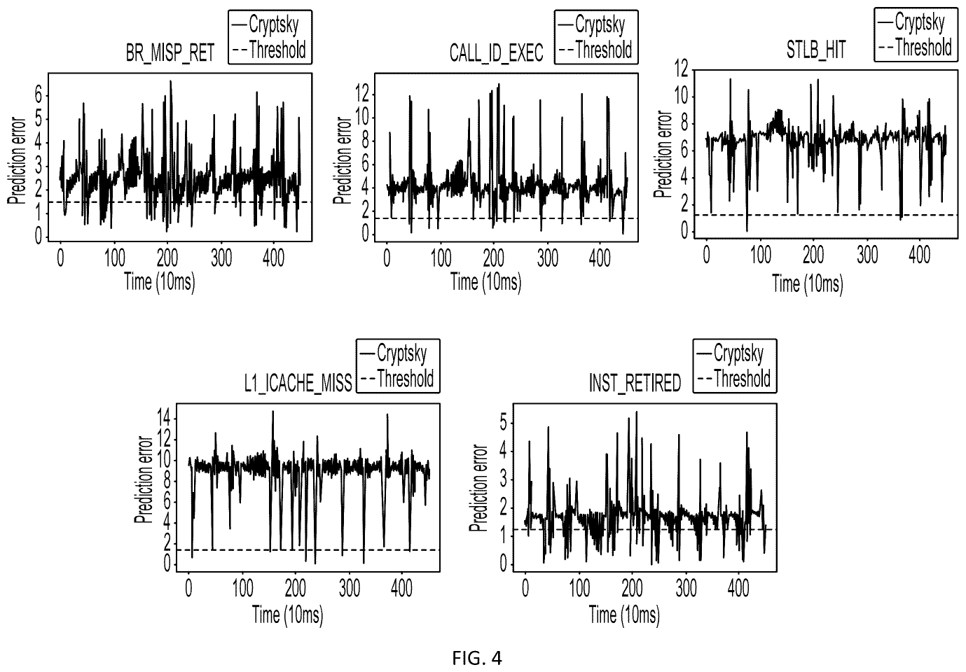

The output of the LSTM model is the anomaly level for each feature, as shown in FIG. 4. The anomaly threshold is generated using empirical rule based on the benign case prediction. If the predicted anomaly level crosses the threshold, it indicates that the system is under attack.

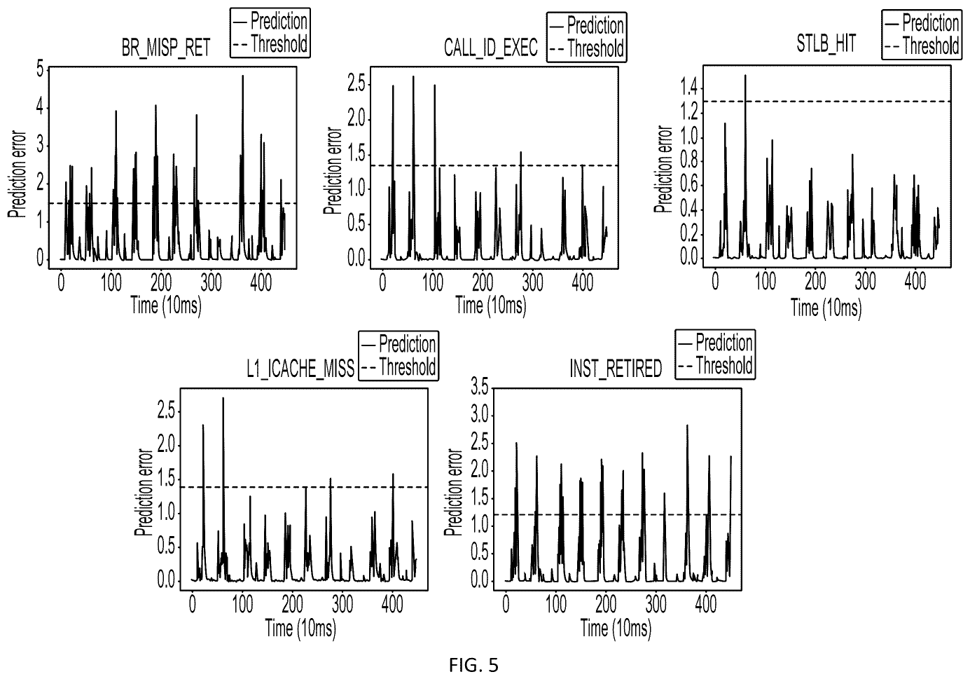

Due to the erratic nature of system behavior, the LSTM network can generate a lot of false positive cases, as shown in FIG. 5. All the data points above the red line (e.g., the threshold) are false positive cases. This is one of the main weaknesses of the anomaly detection model. To address this, statistical methods are employed, such as Weighted Majority Voting (WMV) and Exponential Moving Average (EMA), to reduce these false positive cases.

### WMV and EMA

With WMV, there is a reduction in the number of the false positives that occur in the individuals feature output from FIG. 5, by requiring the majority of the event in the current prediction to indicate abnormality for the final result of that time step to be 1 (malicious).

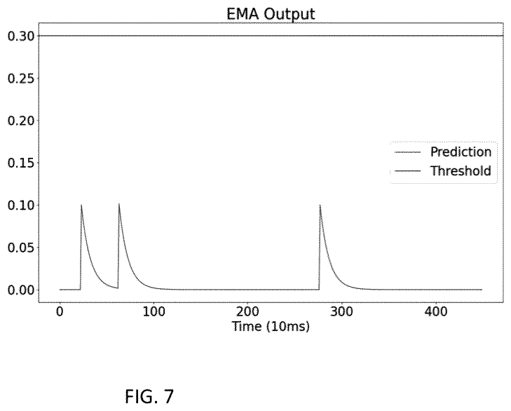

Furthermore, the exponential moving average technique is employed to apply the low pass filter to the WMV output. This can remove the high frequency noise to smooth out the data, which in turn further reduces the number of false positives cases, as shown in the FIG. 7.

### Overall Design

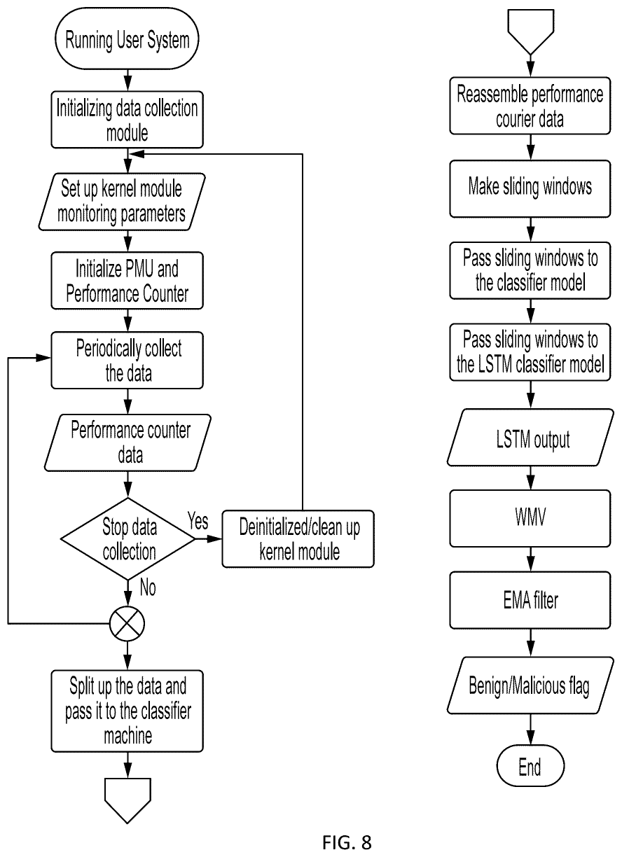

FIG. 8 illustrates the working process of the data collection module and classification module. Starting on a running system (user machine), the data collection module can be initialized by providing the setup parameters such as the hardware events to be monitored and the timer frequency to collect the data (0.1 ms, 1 ms, 10 ms, etc.). The kernel module then uses the parameters to set up the PMU to start counting the hardware event using the hardware performance counter. The hardware event counts are collected periodically by the kernel module. Concurrently, the controller process will extract the performance counter data from the kernel module and then slice it up to prepare to be sent to the classifier machine. The data collection module can be deployed indefinitely to monitor and collect the performance counter data. User can issue the stop command through the controller process to stop monitoring the performance counter and deinitialize the kernel module.

On the classifier machine, after retrieving the performance counter data from the user machine. The fragmented data is then reassembled into a long time-series format. The data preprocessor then generates sliding windows from the new data retrieved from the user machine. The LSTM classifier model takes the sliding windows of data as input for the classification to predict the anomaly level of the data during the sliding window period. The WMV will generate a singular benign/anomaly flag from the LSTM output. The EMA filter is then applied to the WMV output to signify the benign/anomaly flag.

### Example

For example, there is a customer-facing webserver that we are trying to protect. It is assumed that the webserver has not been compromised at the beginning. Since it is connected to the open network to service customers, it is subject to ransomware attack. In the first phase, referred to as the training phase, hardware-level information is collected using either in-house profiling tool or other existing profiling tools, while the webserver is doing its regular work (benign workload). Then, using the collected hardware-level information, the machine-learning-based classification module (classifier) is trained. Once the classifier is trained, this is the end of training phase. In the second phase, referred to as the monitoring phase, the classification module (classifier) is deployed on a separate machine (the classification machine). The classification machine is connected to the webserver via network. The webserver will still be running its regular work, and the data collection module 14 is deployed on the webserver, which will send the collected data to the classification machine 20. This happens in the back end, i.e., the users of the webserver are not aware of this. In the meantime, the classification machine will, using the pre-trained classifier, perform classification on the received data, and make real-time decision if the behavior of the webserver is benign or anomalous. If there is no anomalous behavior detected, the monitoring just continues. The first time the classifier detects an anomalous behavior, the classifier will send a “Warning” signal to the system administrator, indicating that the webserver is possible under ransomware attack, it would be better to check on the webserver. However, if multiple occasions of anomalous behavior are detected, the classifier will send “Anomaly” signal to the system administrator, indicating there is a very high possibility that the webserver is under ransomware attack and immediate action is required.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

Generally, aspects of the invention include:

A system and method for building an anomaly detection framework using low-level hardware information targeting ransomware detection, comprising of two modules: the data collection module and the classifier module.

The system and method above, wherein the data collection module, an aspect of the invention uses the Area Under the Curve (AUC) of the Receiver Operating Characteristic (ROC) curve to select the hardware events to monitor.

The system and method above, wherein the data collection module monitors the entire system behavioral, not just a single software process

The system and method above, wherein the data log is not stored on the user machine, as a precaution in case the user machine is compromised. Additionally, to prevent the data from being captured and exposed during the transmission, the data log is sliced using sliding windows and encrypted, then passed individually via secure SSH tunnels to the classifier machine.

The system and method above, wherein the classifier module uses a semi-supervised machine learning model aided with statistical methods (LSTM+WMV+EMA) to detect benign/malicious behavioral.

The system and method above, wherein the classifier module uses only benign behavioral data of the system during the training of the semi-supervised machine learning model.

The system and method above, wherein the data collection module and the classifier module are calibrated to achieve real-time classification.

The system and method above, wherein having a separate machine for the classifier while the user machine is under monitoring, results a lightweight framework on the user machine by offloading the heavy-weight classification work without impeding the functionality of the user machine.

The system and method above, wherein having a separate machine for the classifier while the user machine is under monitoring, this hierarchical design enables good scalability for the proposed detection framework.

The system and method above, wherein having a separate machine for the classifier while the user machine is under monitoring, allows the classifier machine to enforce strict protection to ensure that the classifier module will not be detected by sophisticated ransomware with detection avoidance capability.

The system and method above can work for difference processor families, such as INTEL, ARM, AMD.

### REFERENCES INCORPORATED BY REFERENCE

[1] A. Taylor, “There's a huge surge in hackers holding data for ransom, and experts want everyone to take these steps.” Fortune.com, Feb. 17, 2022 [Online].
[2] A. Kharaz, S. Arshad, C. Mulliner, W. Robertson, and E. Kirda, “UNVEIL: A Large-Scale, automated approach to detecting ransomware,” in 25th USENIX Security Symposium (USENIX Security 16), (Austin, TX), pp. 757-772, USENIX Association, August 2016.
[3] S. Baek, Y. Jung, D. Mohaisen, S. Lee, and D. Nyang, “SSD-assisted ransomware detection and data recovery techniques,” IEEE Transactions on Computers, vol. 70, no. 10, pp. 1762-1776, 2021.
[4] A. O. Almashhadani, M. Kaiiali, S. Sezer, and P. O'Kane, “A multi-classifier network-based crypto ransomware detection system: A case study of locky ransomware,” IEEE Access, vol. 7, pp. 47053-47067, 2019.
[5] A. Tang, S. Sethumadhavan, and S. Stolfo, “Unsupervised anomaly-based malware detection using hardware features,” in Research in Attacks, Intrusions and Defenses (A. Stavrou, H. Bos, and G. Portokalidis, eds.), vol. 8688 of Lecture Notes in Computer Science, pp. 109-129, Springer International Publishing, 2014.
[6] G. Torres, Z. Yang, Z. Blasingame, J. Bruska, and C. Liu, “Detecting non-control-flow hijacking attacks using contextual execution information,” pp. 1-8, 06 2019.
[7] C. Li and J.-L. Gaudiot, “Detecting malicious attacks exploiting hardware vulnerabilities using performance counters,” in 2019 IEEE 43^{rd} Annual Computer Software and Applications Conference (COMPSAC), vol. 1, pp. 588-597, 2019.
[8] S. Hochreiter and J. Schmidhuber, “Long short-term memory,” Neural Computation, vol. 9, pp. 1735-1780, 1997

What is claimed is:

1. A system for detecting malware on a user computer, comprising:
a. a data collection module comprising profiling software stored and adapted to be executed on the user computer, the profiling software structured, configured or programmed to collect data of hardware events occurring on the user machine based at predetermined intervals and using the collected data to compile a performance counter data structure;
b. a data classification module comprising a recurrent neural network stored and adapted to be executed on a classifier machine that is separate from the user machine, the recurrent neural network processing the performance counter data structure and outputting a classification output that categorizes the data as benign or malicious; and
c. means for notifying an administrator of the classification output.
